(19) United States
(12) Patent Application Publication
(10) Pub. No.: US 2025/0388206 A1
(43) Pub. Date: Dec. 25, 2025

(54) CONTROL DEVICE FOR HYBRID ELECTRIC VEHICLE

(71) Applicant: TOYOTA JIDOSHA KABUSHIKI KAISHA, Toyota-shi (JP)

(72) Inventors: Yukiyasu Yamashita, Nisshin-shi (JP); Naoki Hayashima, Toyota-shi (JP); Yoshiaki Tsuruta, Nagakute-shi (JP); Shogo Kawai, Toyota-shi (JP)

(73) Assignee: TOYOTA JIDOSHA KABUSHIKI KAISHA, Toyota-shi (JP)

(21) Appl. No.: 19/033,506

(22) Filed: Jan. 22, 2025

(30) Foreign Application Priority Data
Jun. 19, 2024 (JP) 2024-098863

(51) Int. Cl. B60W 20/40; B60W 10/02; B60W 10/06

(52) U.S. Cl. CPC B60W 20/40; B60W 10/02; B60W 10/06; B60W 2510/305; B60W 2540/10; B60W 2710/0627

(57) ABSTRACT

An alternator is provided which is driven by an output of an engine to generate electric power, and is capable of EV traveling by an output torque of only a motor, and a fuel cut control device in a hybrid electric vehicle for executing fuel cut for stopping the supply of fuel to the engine when the fuel cut start condition is satisfied. When the alternator is shifted to EV traveling due to EV traveling transition condition being satisfied in a state where the engine is operated and the alternator is operated, when there is an operation request to operate the alternator, the fuel cut is prohibited and the supply of fuel to the engine is continued.

### CROSS-REFERENCE TO RELATED APPLICATION

This application claims priority to Japanese Patent Application No. 2024-098863 filed on Jun. 19, 2024. The disclosure of the above-identified application, including the specification, drawings, and claims, is incorporated by reference herein in its entirety.

### BACKGROUND

### 1. Technical Field

The present disclosure relates to a control device for a hybrid electric vehicle provided with an engine (internal combustion engine) and a motor as power sources.

### 2. Description of Related Art

Japanese Unexamined Patent Application Publication No. 2004-64811 (JP 2004-64811 A) describes a power generation control device for a vehicle, the power generation control device being capable of suppressing overshoot or undershoot of an engine speed after fuel-cut. The power generation control device for a vehicle described in JP 2004-64811 A controls a vehicle (engine vehicle) that includes an alternator driven by the engine to generate electric power. The power generation control device performs power generation by the alternator while performing fuel-cut in which fuel supply to the engine is stopped or limited. In addition, at the same as the fuel supply to the engine is resumed after the fail-cut is ended, the power generation by the alternator is temporarily stopped, and thereafter the voltage of the power generation by the alternator is gradually increased until a predetermined value is reached.

### SUMMARY

By performing the fuel-cut when the vehicle is decelerating or in an accelerator-off state, as in the power generation control device for a vehicle described in JP 2004-64811 A, it is possible to reduce the amount of fuel consumed by the engine and improve the fuel efficiency of the vehicle. In the power generation control device for a vehicle described in JP 2004-64811 A, the state of the power generation by the alternator is controlled according to the timing to execute the fuel-cut. This is intended to resolve overshoot or undershoot of the engine speed after the end of the fuel-cut. Meanwhile, there is provided a hybrid electric vehicle including an alternator driven by an engine to generate electric power, as with the vehicle described in JP 2004-64811 A, and further provided with a motor as a driving force source together with the engine. In this hybrid electric vehicle, when fuel-cut is performed in the same manner as in the conventional engine vehicle, there is a possibility that a catalyst provided in an exhaust system for the engine deteriorates.

For example, in the hybrid electric vehicle provided with an alternator described above, rotation of the engine is maintained when the alternator is actuated. In such a case, when the hybrid electric vehicle is brought into a state (so-called electric vehicle (EV) travel state) in which the hybrid electric vehicle travels using only output torque of the motor, fuel supply to the engine is stopped. Therefore, the engine is substantially brought into a state in which the fuel-cut is performed. As a result, the engine is brought into a lean-burn state in which the amount of fuel is less than the stoichiometric air-fuel ratio, and the amount of nitrogen oxides contained in the exhaust gas of the engine increases. Therefore, if the hybrid electric vehicle transitions to the EV travel state while the alternator is actuated, the catalyst may deteriorate.

The present disclosure can address the above technical issue, and can provide a control device for a hybrid electric vehicle capable of avoiding or suppressing deterioration of a catalyst for an engine that drives an alternator.

An aspect of the present disclosure provides a control device for a hybrid electric vehicle provided with an engine and a motor as driving force sources and including an alternator driven by an output of the engine to generate electric power, the hybrid electric vehicle being able to perform electric vehicle (EV) travel to travel substantially using output torque of only the motor with the engine stopped or driven in an idling state, and the hybrid electric vehicle executing fuel-cut in which fuel supply to the engine is stopped or suppressed when a predetermined fuel-cut starting condition is satisfied, the control device including a control unit that controls the hybrid electric vehicle, in which the control unit is configured to: determine whether there is an actuation request to actuate the alternator when transitioning to the EV travel when a predetermined EV travel transition condition is satisfied in a state in which the engine is driven and the alternator is actuated; and prohibit execution of the fuel-cut and continue the fuel supply to the engine when there is still the actuation request.

In the aspect of the present disclosure, the hybrid electric vehicle may include: a clutch provided between the engine and the motor to selectively shut off power transmission between the engine and the motor; and an automatic transmission provided on an output side of the motor to transmit output torque of the engine and the motor to drive wheels.

In the aspect of the present disclosure, the automatic transmission may be able to set at least a low speed gear or a low gear ratio, a high speed gear or a high gear ratio, and a medium speed gear or a medium gear ratio, the low speed gear or the low gear ratio having a highest gear ratio and being used when starting and stopping the vehicle, the high speed gear or the high gear ratio having a lowest gear ratio and being used when traveling at a high speed, and the medium speed gear or the medium gear ratio being intermediate between the low speed gear or the low gear ratio and the high speed gear or the high gear ratio; the fuel-cut starting condition may include the EV travel transition condition; and the control unit may be configured todetermine that the EV travel transition condition and the fuel-cut starting condition are satisfied and transition to the EV travel when at least the engine is driven, the hybrid electric vehicle is traveling while decelerating in an accelerator-off state in which there is no acceleration request operation by a driver, and the medium speed gear or the medium gear ratio or the high speed gear or the high gear ratio is set in the automatic transmission, and prohibit execution of the fuel-cut and continue fuel supply to the engine without executing the fuel-cut when there is the actuation request when transitioning to the EV travel, even if the fuel-cut starting condition is satisfied.

In the aspect of the present disclosure, the control unit may shut off the power transmission between the engine and the motor by disengaging the clutch when performing the EV travel.

The hybrid electric vehicle to be controlled in the present disclosure includes an alternator driven by the engine to generate electric power. Further, the hybrid electric vehicle to be controlled in the present disclosure is capable of EV travel to travel substantially using only output torque of the motor with the engine stopped or driven in an idling state. The hybrid electric vehicle to be controlled in the present disclosure is further capable of executing fuel-cut to reduce the amount of fuel consumed by the engine. In addition, the control device for a hybrid electric vehicle according to the present disclosure occasionally transitions from a state in which the engine is driven to output torque to a state of the EV travel described above. At this time, it is determined whether there is an actuation request for the alternator. When power generation by the alternator is necessary and there is an actuation request for the alternator, execution of the fuel-cut is prohibited. In this case, fuel supply to the engine is continued without executing the fuel-cut, even if the fuel cut start condition is satisfied. Therefore, even when the hybrid electric vehicle transitions to the EV travel during the actuation of the alternator, the fuel supply is continued without executing the fuel-cut, and the operation state of the engine is maintained. By continuing fuel supply to the engine, it is possible to avoid the engine from unexpectedly falling into a lean-burn state.

Thus, the control device for a hybrid electric vehicle according to the present disclosure controls a hybrid electric vehicle that includes an alternator driven by an engine to generate electric power. According to the control device for a hybrid electric vehicle according to the present disclosure, it is possible to avoid or suppress deterioration of a catalyst provided in an exhaust system of the engine regardless of the behavior of the hybrid electric vehicle, such as an actuation request for the alternator and transition to EV travel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing a configuration of a hybrid electric vehicle to be controlled according to the present disclosure, and schematically shows a drive system and a control system thereof; and

FIG. 2 is a flow chart for explaining an exemplary control executed by the control device of hybrid electric vehicle of the present disclosure.

### DETAILED DESCRIPTION OF EMBODIMENTS

An embodiment of the present disclosure will be described with reference to the drawings. It should be noted that the embodiments shown below are merely examples of cases where the present disclosure is embodied, and do not limit the present disclosure.

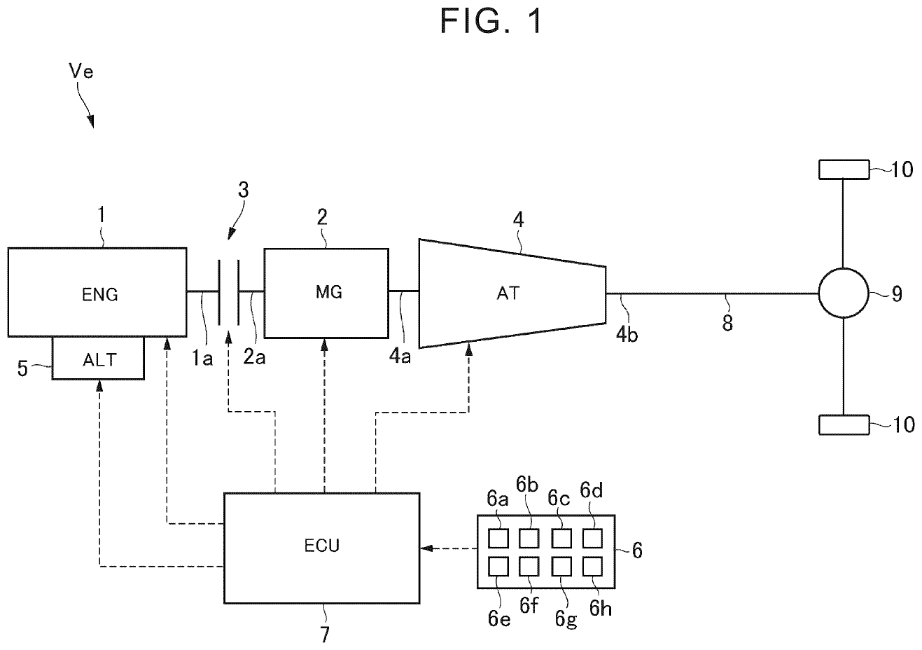

FIG. 1 schematically illustrates an exemplary drive system and a control system of a hybrid electric vehicle to be controlled in an embodiment of the present disclosure. A hybrid electric vehicle (hereinafter, referred to as a vehicle) Ve illustrated in FIG. 1 is equipped with an engine (ENG) 1 and a motor (MG) 2 as driving force sources. Further, the vehicle Ve includes a clutch 3, an automatic transmission (AT) 4, an alternator (ALT) 5, a detection unit 6, and a control unit (ECU) 7.

It should be noted that the vehicle Ve to be controlled in the embodiment may be an internal combustion engine such as the engine 1 and a “hybrid electric vehicle” equipped with at least one “motor” as the driving force source. As shown in FIG. 1, the vehicle Ve transmits the output torque of the engine 1 and the motor 2 to the rear wheels (drive wheels) 10 via the automatic transmission 4, the propeller shaft 8, and the differential gear 9. The vehicle Ve may be a rear wheel drive (FR) vehicle that generates a driving force on the rear wheels 10. Alternatively, the vehicle Ve may be a front wheel drive vehicle (not shown) that transmits the output torque of the engine 1 and the motor 2 to a front wheel (not shown) and generates a driving force by the front wheel. Alternatively, the vehicle Ve may be a four-wheel drive vehicle (not shown) provided with a transfer mechanism (not shown) to transmit the output torque of the motor 2 to both the front wheels and the rear wheels 10 and to generate a driving force by both the front wheels and the rear wheels 10.

In addition, Ve of vehicles to be controlled in the embodiment may be a so-called “FR 1-motor type hybrid electric vehicle” as shown in FIG. 1. In addition, for example, a well-known “parallel hybrid electric vehicle” may be used. Alternatively, it may be a series-parallel (or split-type) “hybrid electric vehicle”. For example, it may be a “split-type hybrid electric vehicle” with “engines” and two “motors” and “power split mechanisms (planetary gear sets)”.

In the vehicle Ve illustrated in FIG. 1, the engine 1 is an internal combustion engine, such as a gasoline engine or a diesel engine, that burns fuel to obtain power. The engine 1 is configured in such a way that the output is adjusted and the operating states, such as starting and stopping, are electrically controlled. In the case of a gasoline engine, an opening degree of a throttle valve, a supply amount or an injection amount of fuel, an injection timing of fuel, an execution and a stop of ignition, an ignition timing, and the like are electrically controlled. An alternator 5, which will be described later, is connected to the engine 1 so as to be capable of transmitting power, and drives the alternator 5 by the output torque of the engine 1. In addition, a general catalytic converter (not shown) is provided in an exhaust system (not shown) of the engine 1. As will be described later, in the control device of hybrid electric vehicle according to the embodiment of the present disclosure, the presence or absence of an operation demand for the alternator 5 is determined in order to protect the catalytic converter. On the basis of the determination result, the control device executes various controls for determining whether or not the fuel cut for the engine 1 can be performed.

The motor 2 is constituted by, for example, a permanent magnet synchronous motor or an induction motor. The motor 2 has at least a function as a prime mover that is driven by being supplied with electric power to output torque. Further, the motor 2 may function as a generator that generates electric power by being driven by receiving torque from the outside. That is, the motor 2 may be a so-called motor generator having both a function as a prime mover and a function as a generator. A battery (not shown) is connected to the motor 2 via an inverter (not shown). Therefore, the electric power stored in the battery can be supplied to the motor 2, and the motor 2 can function as a prime mover to output the driving torque. In addition, the motor 2 can function as a generator by the torque transmitted from the drive wheels 10, and the regenerative electric power generated at that time can be stored in the battery. In the motor 2, the output rotational speed and the output torque are electrically controlled by a control unit 7 to be described later. For example, the required driving force is calculated from the operation amount and the vehicle speed of the accelerator pedal (not shown) by the driver, and the output torque of the motor 2 is controlled based on the required driving torque (that is, the control target value of the motor 2) set corresponding to the required driving force.

The clutch 3 is provided between the engine 1 and the motor 2. Specifically, the output shaft 1a of the engine 1 and the input shaft (input-side of the rotary shaft) 2a of the motor 2 are coupled to each other via the clutch 3. Therefore, by controlling the engagement and disengagement states of the clutch 3, the power transmission between the engine 1 and the motor 2 is selectively interrupted. For example, as will be described later, when a so-called EV travel is performed in which the vehicle Ve is driven by the output torque of only the motor 2, the clutch 3 is released to shut off power transmission between the engine 1 and the motor 2. This reduces the drag loss caused by the engine 1 and improves the energy-efficiency during EV running.

The automatic transmission 4 is a power transmission that transmits the output torque of the engine 1 and the motor 2 to the drive wheels 10, and is a transmission that changes the rotational speed of the engine 1 or the motor 2 and transmits the output torque. The automatic transmission 4 is a power transmission device capable of appropriately changing the ratio of the rotational speed of the input shaft 4a to the rotational speed of the output shaft 4b, that is, the gear ratio, and automatically controls the control of changing the gear ratio (transmission stage), that is, the transmission control. The automatic transmission 4 may be, for example, a “stepped automatic transmission” that sets a plurality of transmission stages having different gear ratios. Alternatively, it may be a “belt-type continuously variable transmission” in which the gear ratio can be changed continuously. Therefore, the automatic transmission 4 can set at least a low-speed or low-gear ratio (for example, a first speed), a high-speed or high-gear ratio (for example, a fifth speed or a sixth speed), a medium-speed or medium-gear ratio (for example, a second speed, a third speed or a fourth speed). The low-speed transmission stage or the low-speed gear ratio (for example, the first speed) has the largest gear ratio and is used at the time of starting and stopping. The high-speed transmission stage or the high-speed gear ratio (for example, the fifth speed or the sixth speed) has the smallest gear ratio and is used during high-speed running. The medium-speed or medium-gear ratio (for example, the second, third, and fourth speeds) is intermediate between the low-speed or low-gear ratio and the high-speed or high-gear ratio.

The alternator 5 is an “alternator” that is driven by the output of the engine 1 and generates electricity. The alternator 5 is connected to the output shaft 1a of the engine 1 via a fan belt (not shown) or the like, and is driven by the output torque of the engine 1. Electricity generated by the alternator 5 is stored in an auxiliary battery (a secondary battery such as a lead storage battery; not shown) or the like. Then, for example, when the remaining charge amount of the auxiliary battery becomes equal to or less than a predetermined value, an operation request for the alternator 5 is output, and the alternator 5 is operated. Specifically, the rotation of the engine 1 is maintained to drive the alternator 5, and the alternator 5 is operated.

The detection unit 6 is a device or a device for acquiring various types of data and information required for controlling the vehicle Ve, and includes, for example, a power supply unit, a microcomputer, a sensor, an input/output interface, and the like. The detection unit 6 detects a traveling state, a control state, and the like of the vehicle Ve. At the same time, the detection unit 6 detects, among other things, various data for determining whether or not the alternator 5 is required to operate, various data for performing fuel-cut of the engine 1, and various data for performing EV travel.

Specifically, the detection unit 6 includes, for example, a vehicle speed sensor 6a that detects a vehicle speed, an engine speed sensor 6b that detects a speed of the engine 1, a motor speed sensor (or a resolver) 6c that detects a speed of the motor 2, and a motor current sensor 6d that detects a current of the motor 2. The detection unit 6 further includes an accelerator operation amount sensor 6e for detecting a depression amount or a depression angle of an accelerator pedal (not shown), a SOC sensor 6f for detecting a remaining charge amount (SOC) of the auxiliary battery, a shift position sensor 6g for detecting a present transmission stage (gear ratio) of the automatic transmission 4, a timer 6h for detecting a detection time and a timing of each sensor, a control time of each unit, and the like. The detection unit 6 is electrically connected to a control unit 7, which will be described later, and outputs, to the control unit 7, an electrical signal corresponding to a detection value or a calculated value of various sensors, devices, and the like as described above, as detection data.

The control unit 7 is, for example, an electronic control device mainly composed of a microcomputer. The control unit 7 controls the motor 2 for driving the vehicle to control the driving force of the vehicle Ve. Various data and the like detected or calculated by the detection unit 6 are input to the control unit 7. The control unit 7 performs an operation using various input data, data stored in advance, a calculation formula, and the like. The control unit 7 is configured to output the calculation result as a control command signal and to control the running state of the vehicle Ve, the operating state of the driving force source (the engine 1 and the motor 2), and the like, as described above. In particular, in the control device of hybrid electric vehicle according to the embodiment of the present disclosure, as will be described later, various controls for determining whether or not the alternator 5 is required to operate are executed. In the control device, various controls for performing fuel-cut of the engine 1, various controls for performing EV traveling, and the like are executed.

Although FIG. 1 shows an example in which one control unit 7 is provided, the control unit 7 in the embodiment of the present disclosure may be provided separately for each apparatus or device to be controlled or for each control content.

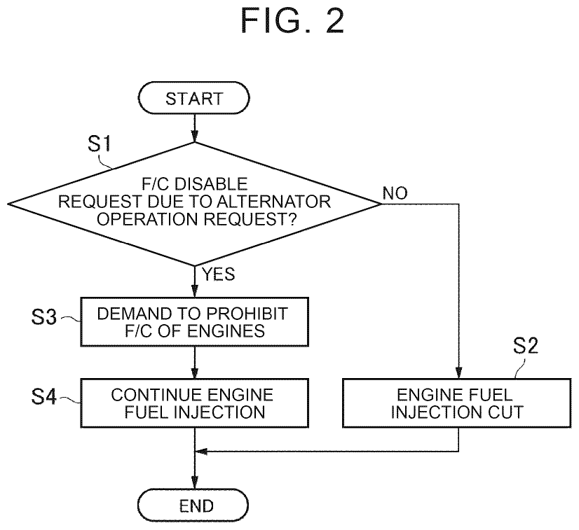

As described above, the control device of hybrid electric vehicle according to the embodiment of the present disclosure controls hybrid electric vehicle Ve including the alternator 5 driven by the engine 1. The control device is configured to prevent or suppress deterioration of the catalyst provided in the exhaust system of the engine 1. An example of the control executed in the control unit 7 for this purpose is shown in the flowchart of FIG. 2.

The control shown in the flow chart of FIG. 2 is executed when the engine 1 is in operation, that is, when the alternator 5 is in operation in response to the output torque of the engine 1, and when shifting from that state to EV running. EV traveling is a traveling mode in which the vehicle Ve travels only by the output torque of the motor 2, and a torque for traveling is output by the motor 2. At the same time, operation of the engine 1 is stopped. Alternatively, the engine 1 is operated in an idling rotation state. That is, in EV running condition, the fuel-supply to the engine 1 is stopped or restricted. Therefore, the engine 1 is operated at a low rotational speed of about stop or idling. As described above, during EV running, the clutch 3 may be released in order to reduce drag loss caused by the engine 1.

In addition, EV traveling is shifted to EV traveling when a predetermined EV traveling transition condition is satisfied. EV running transition conditions are, at least, that the engine 1 is being operated, that the vehicle Ve is being decelerated and traveling in a state in which there is no acceleration request operation by the driver, and that a medium speed change stage or a medium gear ratio or a high speed change stage or a high gear ratio is set in the automatic transmission 4. When all of these conditions are satisfied, it is determined that EV travel transition condition is satisfied. EV travel transition condition is included in the fuel cut initiation condition. That is, EV travel transition condition overlaps with a part of the fuel-cut initiation condition. Therefore, when EV traveling transition condition is satisfied, the fuel-cut starting condition is also once satisfied.

However, when the above-described EV running transition condition is satisfied (that is, the fuel cut initiation condition is also satisfied) and the vehicle Ve shifts to EV running, the alternator 5 is required to operate, and the fuel cut may be performed while the operation of the engine 1 is continued. In this case, the engine 1 is in a lean burn state. As a result, the amount of nitrogen oxides contained in the exhaust of the engine 1 increases, and deterioration of the catalyst in the exhaust system of the engine 1 progresses. Therefore, the control device of hybrid electric vehicle according to the embodiment determines whether or not the alternator 5 is required to operate when EV travel transition condition is satisfied. When there is a request to operate the alternator 5, the control device prohibits the engine 1 from performing a fuel cut.

Specifically, as shown in the flow chart of FIG. 2, first, in S1, it is determined whether there is a prohibition request for fuel cut (F/C) caused by the operation request of the alternator 5. As described above, for example, when the remaining charge amount of the auxiliary battery becomes equal to or less than a predetermined value, an operation request for the alternator 5 is output, and power generation by the alternator 5 is performed. Accordingly, the rotation of the engine 1 is maintained in order to drive the alternator 5 when there is an activation request for the alternator 5. When the vehicle Ve shifts to EV travel while the engine 1 is rotating as described above, the supply of fuel to the engine 1 is stopped, that is, when the fuel cut is executed, as described above, degradation of the catalyst in the exhaust system of the engine 1 may progress.

Therefore, in the control device of hybrid electric vehicle according to the embodiment of the present disclosure, when the vehicle Ve shifts to EV travel while the operation of the alternator 5 is requested as described above, the fuel-cut operation of the engine 1 is prohibited. That is, a fuel cut prohibition request resulting from the operation request of the alternator 5 is output. When the prohibition request of the fuel cut is output, the execution of the fuel cut is prohibited, and the fuel supply to the engine 1 is continued. Further, when Ve shifts to EV travel, when there is no need to operate the alternator 5 as described above, the fuel-supply to the engine 1 is stopped. That is, the fuel cut is executed.

Therefore, if S1 determines “No” due to the absence of the prohibition request for fuel-cutting due to the operation request of the alternator 5 because there is no operation request for the alternator 5, the process proceeds to S2 and the fuel-supply to the engine 1 is stopped. That is, the fuel cut is executed. Then, the routine shown in the flowchart of FIG. 2 is temporarily ended.

On the other hand, if it is determined that S1 is “Yes” due to the prohibition request of the fuel cut due to the operation request of the alternator 5 due to the operation request of the alternator 5, the process proceeds to S3 and S4.

In S3, a fuel-cut prohibition request is outputted to the engine 1. That is, the execution of the fuel cut for the engine 1 is prohibited.

Then, in S4, the fuel is continuously supplied to the engine 1 (fuel injection) because the fuel cut is prohibited from being executed in the above-described S3. Then, the routine shown in the flowchart of FIG. 2 is temporarily ended.

As described above, in the control device of hybrid electric vehicle according to the embodiment of the present disclosure, there is a case where EV traveling state is shifted from the state in which the engine 1 is operated and outputs torque to the state in which the engine is driven by the output torque of the motor 2. At this time, the presence or absence of an operation request for the alternator 5 is determined. Then, when power generation by the alternator 5 is necessary and there is an operation request of the alternator 5, execution of the fuel cut is prohibited. In this case, even if the fuel cut start condition is satisfied, the fuel cut is not executed, and the fuel supply to the engine 1 is continued. Therefore, even when the vehicle Ve shifts to EV travel during the operation of the alternator 5, the fuel cut is not executed and the operation of the engine 1 is maintained when the operation of the alternator 5 is required. By continuing the supply of fuel to the engine 1, it is possible to prevent the engine 1 from becoming unexpectedly lean burn.

Therefore, according to the control device of hybrid electric vehicle in the embodiment of the present disclosure, a hybrid electric vehicle Ve including the alternator 5 driven by the engine 1 to generate electric power is targeted. According to the control device, it is possible to prevent or suppress degradation of the catalytic converter provided in the exhaust system of the engine 1 regardless of the behavior of hybrid electric vehicle Ve, such as the operation requirement of the alternator 5 and the transition to EV travel.

What is claimed is:

1. A control device for a hybrid electric vehicle provided with an engine and a motor as driving force sources and including an alternator driven by an output of the engine to generate electric power, the hybrid electric vehicle being able to perform electric vehicle (EV) travel to travel using output torque of only the motor, and the hybrid electric vehicle executing fuel-cut in which fuel supply to the engine is stopped or suppressed when a predetermined fuel-cut starting condition is satisfied, the control device comprising
a control unit that controls the hybrid electric vehicle, wherein
the control unit is configured to:
determine whether there is an actuation request to actuate the alternator when transitioning to the EV travel when a predetermined EV travel transition condition is satisfied in a state in which the engine is driven and the alternator is actuated; and
prohibit execution of the fuel-cut and continue the fuel supply to the engine when there is the actuation request.

2. The control device according to claim 1, wherein
the hybrid electric vehicle includes:
a clutch provided between the engine and the motor to selectively shut off power transmission between the engine and the motor; and
an automatic transmission provided on an output side of the motor to transmit output torque of the engine and the motor to drive wheels.

3. The control device according to claim 2, wherein:
the automatic transmission is able to set at least a low speed gear or a low gear ratio, a high speed gear or a high gear ratio, and a medium speed gear or a medium gear ratio, the low speed gear or the low gear ratio having a highest gear ratio and being used when starting and stopping the vehicle, the high speed gear or the high gear ratio having a lowest gear ratio and being used when traveling at a high speed, and the medium speed gear or the medium gear ratio being intermediate between the low speed gear or the low gear ratio and the high speed gear or the high gear ratio;
the fuel-cut starting condition includes the EV travel transition condition; and
the control unit is configured to
determine that the EV travel transition condition and the fuel-cut starting condition are satisfied and transition to the EV travel when at least the engine is driven, the hybrid electric vehicle is traveling while decelerating in an accelerator-off state in which there is no acceleration request operation by a driver, and the medium speed gear or the medium gear ratio or the high speed gear or the high gear ratio is set in the automatic transmission, and
not execute the fuel-cut when there is the actuation request when transitioning to the EV travel, even if the fuel-cut starting condition is satisfied.

4. The control device according to claim 3, wherein the control unit shuts off the power transmission between the engine and the motor by disengaging the clutch when performing the EV travel.
